(19) United States
(12) Patent Application Publication
(10) Pub. No.: US 2017/0351387 A1
(43) Pub. Date: Dec. 7, 2017

(54) QUICK TRACE NAVIGATOR

(71) Applicant: eBay Inc., San Jose, CA (US)

(72) Inventors: Menghui Li, Shanghai (CN); Qi Jiang, Shanghai (CN); Christopher Michael Hall, San Jose, CA (US); Shannon B. Vosseller, San Francisco, CA (US); Sergio Pinzon Gonzales, JR., San Jose, CA (US)

(21) Appl. No.: 15/171,711

(22) Filed: Jun. 2, 2016

(51) Int. Cl. G06F 3/0482; G06F 17/30; G06F 3/0488; G06T 1/00; G06F 17/24

(52) U.S. Cl. CPC G06F 3/0482; G06F 17/30902; G06F 3/04883; G06F 17/243; G06T 1/0021

(57) ABSTRACT

Aspects of the present disclosure relate to a network-based quick trace navigation system that includes a client device in communication with an application server executing the quick trace navigation system over a network. For example, the quick trace navigation system may be or include a group of one or more server machines. Users of the quick trace navigation system are presented with a navigation menu that includes a presentation of screenshots of pages previously accessed by a user of a client device.

### TECHNICAL FIELD

The subject matter of the present disclosure generally relates to user interfaces for client devices. In particular, example embodiments relate to a user interface for displaying previously visited web pages on client devices.

### BACKGROUND

Mobile devices are quickly becoming the primary means by which individuals browse the Internet. Individuals therefore rely on mobile devices to perform various tasks such as searching for information, browsing news, and purchasing commodities. While applications do exist to streamline these tasks, individuals often still need to use a more standard browser to navigate to different web pages. The traditional back arrow normally found in a web browser allows users to go back to the previous page; however, it has some restrictions. For example, the back arrow only allows the user to go back to the last page, so the user would need to click the back arrow multiple times to go back to a specific page. The back arrow also requires time to reload the previous pages. In addition, mobile devices often have small displays which may make accurately selecting a back arrow icon difficult.

### BRIEF DESCRIPTION OF THE DRAWINGS

Various ones of the appended drawings merely illustrate example embodiments of the present disclosure and are not intended to limit its scope to the illustrated embodiments. On the contrary, these examples are intended to cover alternatives, modifications, and equivalents as may be included within the scope of the disclosure.

FIG. 1 is a network diagram illustrating a networked system having a client-server architecture configured for exchanging data over a network with a quick trace navigation system, according to example embodiments.

FIG. 2 is a block diagram illustrating various functional components of a quick trace navigation system, which is provided as part of the networked system, according to example embodiments.

FIG. 3 is a flow chart illustrating a method for generating and causing display of a navigation menu at a client device, according to example embodiments.

FIG. 4 is a flow chart illustrating a method for generating screenshots of web pages for use in a navigation menu, according to an example embodiment.

FIG. 5 is a flow chart illustrating a method for retrieving a set of instructions to generate a screenshot for display within a navigation menu, according to an example embodiment.

FIG. 6 is an interface diagram illustrating a user interface displaying a web page generated based on a set of instructions at a client device, according to an example embodiment.

FIG. 7 is an interface diagram illustrating a navigation menu containing screenshots of web pages that a user has previously accessed overlaid upon a user interface at a client device, according to an example embodiment.

FIG. 8 is an interface diagram illustrating a navigation menu containing a screenshot, according to an example embodiment.

FIG. 9 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter of the present disclosure. In the following description, specific details are set forth in order to provide a thorough understanding of the subject matter. It shall be appreciated that embodiments may be practiced without some or all of these specific details.

Aspects of the present disclosure relate to a network-based quick trace navigation system that includes a client device in communication with an application server executing the quick trace navigation system over a network. For example, the quick trace navigation system may be or include a group of one or more server machines. Users of the quick trace navigation system are presented with a navigation menu that includes a presentation of screenshots of addressed pages previously accessed by a user of a client device.

The quick trace navigation system catalogues and indexes page addresses that a user visits within a memory location of a database associated with the user. For example, the user may browse the Internet via a client device configured to execute a quick trace navigation application. As the user browses the Internet, the quick trace navigation application and quick trace navigation system cache the page addresses accessed by the user via the client device, along with a screenshot of the web page accessed. In this way, the quick trace navigation system collects and stores a navigation history of the user during a browsing session. To access a web page previously viewed, the user provides a user input to the client device to display a navigation menu. In response to receiving the user input, the client device causes display of the navigation menu within a portion of the display. The navigation menu includes a presentation of screenshots of the web pages previously accessed by the user.

The user input may include a tactile input into a touch enabled device, such as a downward or upward swiping motion from a side of the interface. In response to receiving the user input, the quick trace navigation system causes display of a navigation menu within a portion of the interface of the client device. The navigation menu may extend from a side of the interface in response to receiving the user input. The navigation menu includes a presentation of screenshots of addressed pages which the user previously accessed. In some example embodiments, the screenshots may be presented as thumbnail images depicting a state of the web page at the moment in which the user input is received. The user of the client device may select a thumbnail within the presentation to navigate to a corresponding web page.

In additional example embodiments, the quick trace navigation system clusters similar pages accessed by the user (and cached in the database) and suggests pages or content to the user based on the clusters. The suggested pages and content may additionally be presented within the navigation menu. For example, the quick trace navigation system may cluster pages into groups based on content of the pages, and present the user with content or pages when the user accesses a page from a cluster.

For purposes of illustration, consider an example from the perspective of a user of a client device configured to execute the quick trace navigation application, as discussed above. The user may browse the Internet (or networked environment) with the client device by providing a page address into a browser. The quick trace navigation system receives the page address from the client device, captures a screenshot of the associated web page, and caches the page address and the screenshot within a memory location in a database associated with the user. As the user continues to browse the Internet with the client device, the quick trace navigation system caches screenshots and page addresses within the database.

To go back to a page previously accessed, the user may provide a user input, such as a swiping motion into the client device, and in response, the quick trace navigation system causes display of a navigation menu within a portion of the interface that includes a set of thumbnail images depicting the screenshots of the pages. The user may then search through the screenshots to find a desired page. Upon selecting a page from among the screenshots, the quick trace navigation system navigates the user to a corresponding web page based on the page address.

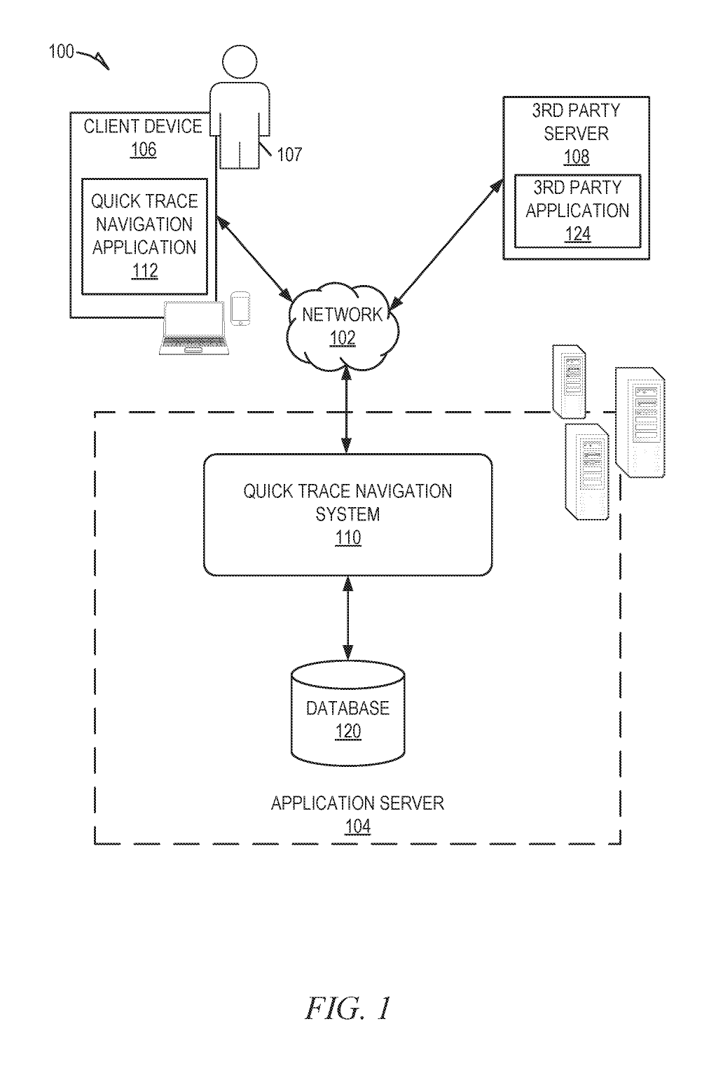

FIG. 1 is a network diagram depicting a networked system 100 having a client-server architecture configured for exchanging data over a network 102 with an application server 104, according to example embodiments. While the networked system 100 is depicted as having a client-server architecture, the present inventive subject matter is, of course, not limited to such an architecture, and could equally well find application in an event-driven, distributed, or peer-to-peer architecture system, for example. Further, to avoid obscuring the inventive subject matter with unnecessary detail, various functional components that are not germane to conveying an understanding of the inventive subject matter have been omitted from FIG. 1. Moreover, it shall be appreciated that although the various functional components of the networked system 100 are discussed in a singular sense, multiple instances of any one of the various functional components may be employed.

As shown, the networked system 100 includes the application server 104 in communication with a client device 106 and a third party server 108 over the network 102. The application server 104 communicates and exchanges data with entities within the networked system 100 that pertain to various functions and aspects associated with the networked system 100 and its users. These data exchanges may include transmitting, receiving (communicating), and processing data to, from, and regarding content and users of the networked system 100.

The application server 104 includes a quick trace navigation system 110 to provide server-side functionality, via the network 102 (e.g., the Internet), to client devices such as the client device 106. The client device 106 may be operated by a user 107, who uses the networked system 100 to browse the Internet via the client device 106.

The client device 106 may be any sort of mobile device (e.g., smart phone, tablet computer, or wearable device) that includes input/output components (e.g., touch screen) for displaying content and receiving user inputs, and a quick trace navigation application 112 specifically designed for interacting with the application server 104. For example, a user 107 may use the quick trace navigation application 112 executing on the client device 106 to navigate to websites previously accessed by the user 107 on the client device 106 using a quick trace navigation menu generated by the application server 104. The quick trace navigation application 112 further provides graphical user interfaces (GUIs) that display the navigation menu generated by the quick trace navigation system 110. The quick trace navigation application 112 may, in some embodiments, when executed by the client device 106, configure the client device 106 to perform any of the methodologies described herein.

Turning specifically to the application server 104, the application server 104 includes the quick trace navigation system 110 and a database 120. In some embodiments, the application server 104 may include an Application Programming Interface (API) server and/or a web server coupled to (e.g., via wired or wireless interfaces) the quick trace navigation system 110 to provide programmatic and/or web interfaces respectively to the client device 106. The application server 104 may, in some embodiments, also include a database server coupled to the quick trace navigation system 110 to facilitate access to the database 120. The database 120 may include multiple databases that may be internal or external to the application server 104.

The quick trace navigation system 110 hosts one or more applications, such as a server-side navigation menu application that provides navigation services to users (e.g., user 107) who access the application server 104. For example, a user 107 may use the quick trace navigation application 112 executing on the client device 106 to display a navigation menu that includes a presentation of screenshots depicting a set of web pages previously accessed by the user 107 on the client device 106. As a further example, the quick trace navigation system 110 may provide data to the client device 106 to populate the interface that displays the navigation menu In some instances, the quick trace navigation system 110 provides such data based on a search request received from the client device 106.

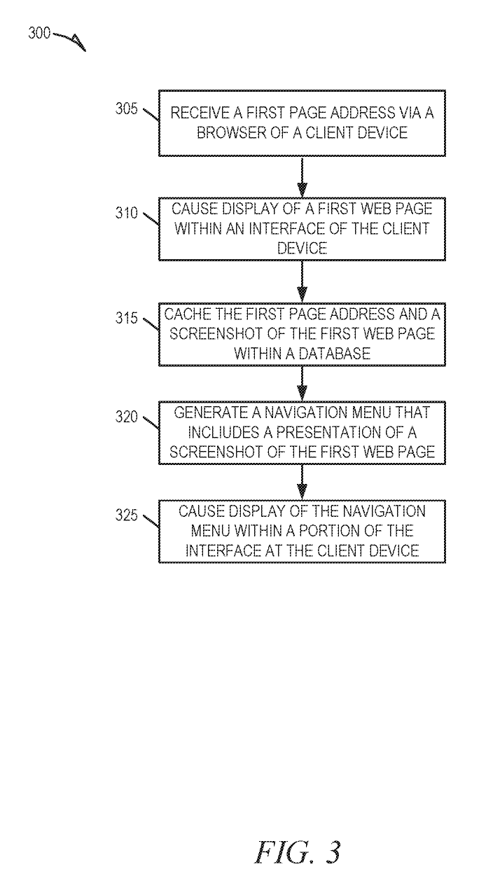

The database 120 stores data pertaining to various functions and aspects associated with the networked system 100 and its users. For example, the database 120 stores a navigation history of the user 107 on the client device 106. The database 120 further stores web page addresses accessed by the user 107 on the client device 106. The database 120 also stores and maintains user account records for users of the application server 104. Each user account record is a data structure that includes information describing aspects of a particular user. Further details regarding an example account record stored in the database 120 are discussed below in reference to FIG. 3.

FIG. 1 also illustrates a third party application 124 executing on the third party server 108 that may offer information or services to the quick trace navigation system 110 or to users of the client device 106. For example, the third party application 124 may be associated with any organization that conducts transactions with or provides services to users of the client device 106 (such as a network-based marketplace). In some embodiments, the incentives provided to users may be redeemed or otherwise used with the third party application 124.

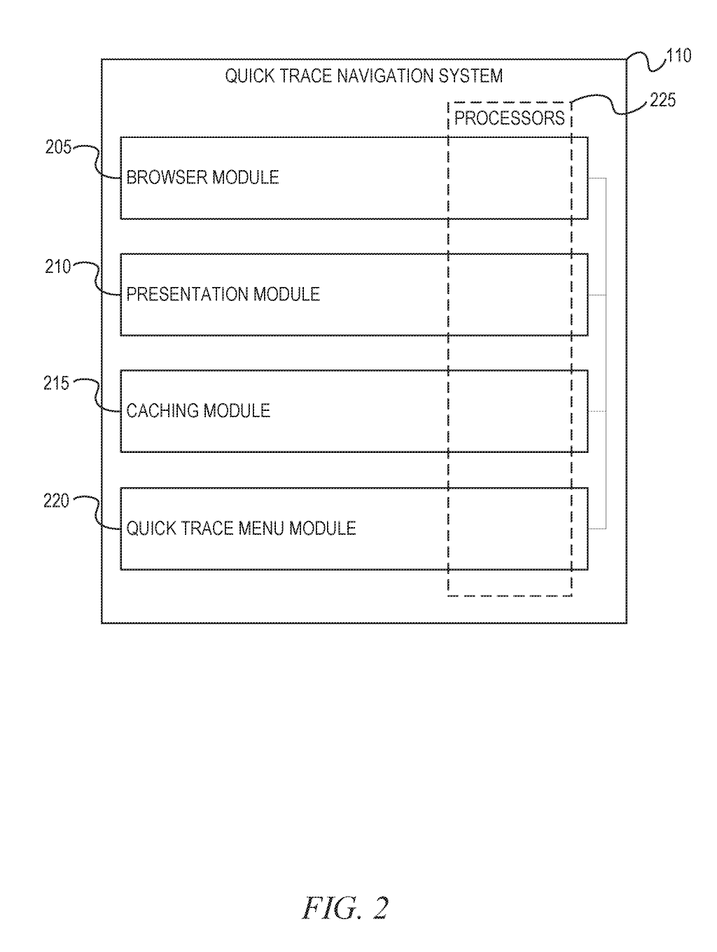

FIG. 2 is a block diagram illustrating components of the quick trace navigation system 110 that configure the quick trace navigation system 110 to receive a page address from a client device 106, cache the page address within a database, and generate and cause display of a navigation menu at the client device, according to some example embodiments. The quick trace navigation system 110 is shown as including a browser module 205, a presentation module 210, a caching module 215, and a quick trace menu module 220, all configured to communicate with each other (e.g., via a bus, shared memory, or a switch). Any one or more of these modules may be implemented using one or more processors 225 (e.g., by configuring such one or more processors to perform functions described for that module) and hence may include one or more of the processors 225.

Any one or more of the modules described may be implemented using hardware alone (e.g., one or more of the processors 225 of a machine) or a combination of hardware and software. For example, any module described of the quick trace navigation system 110 may physically include an arrangement of one or more of the processors 225 (e.g., a subset of or among the one or more processors of the machine) configured to perform the operations described herein for that module. As another example, any module of the quick trace navigation system 110 may include software, hardware, or both, that configure an arrangement of one or more processors 225 (e.g., among the one or more processors of the machine) to perform the operations described herein for that module. Accordingly, different modules of the quick trace navigation system 110 may include and configure different arrangements of such processors 225 or a single arrangement of such processors 225 at different points in time. Moreover, any two or more modules of the quick trace navigation system 110 may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 3 is a flow chart illustrating a method 300 for generating and causing display of a navigation menu, according to an example embodiment. The method 300 may be embodied in computer-readable instructions for execution by one or more processors (e.g., processors 225 of FIG. 2) such that the steps of the method 300 may be performed in part or in whole by functional components (e.g., modules) of the client device 106 or the quick trace navigation system 110; accordingly, the method 300 is described below by way of example with reference thereto. However, it shall be appreciated that the method 300 may be deployed on various other hardware configurations and is not intended to be limited to the functional components of the client device 106 or the quick trace navigation system 110.

At operation 305, the browser module 205 receives a page address (e.g., a Uniform Resource Locator (URL)) from the client device 106. A user 107 may provide the page address through a browser interface presented on the client device 106 by the presentation module 210. The browser module 205 accesses a data source to retrieve a set of instructions to render the web page at the client device 106. For example, the browser module 205 may access the third party server 108 based on the URL and retrieve a set of instructions to render the web page at the client device from the third party server 108.

At operation 310, the presentation module 210 renders and causes display of a web page based on the set of instructions retrieved by the browser module 205. For example, the web page may include content such as sets of images, as well as a fillable form to receive user inputs (e.g., a text string) or user selections. To cause display of the web page, the presentation module 210 accesses the set of instructions to render the visual and functional components of the web page within a display of the client device 106. For example, the set of instructions may include perceived information to render the visible aspects of the web page such as: textual information with diverse render variations; non-textual information including static images and raster graphics (e.g., Graphics Interchange Format (GIF), Joint Photographic Experts Group (JPEG), Portable Network Graphics (PNG), Scalable Vector Graphics (SVG), Flash): and interactive media including interactive text (e.g., Dynamic HTML (DHTML)), interactive illustrations, buttons, hyperlinks, and fillable forms. The set of instructions may further include hidden (internal) information to provide functionality and interactive features to the web page such as: comments, linked files through hyperlinks (e.g., DOC, XLS, PDF, etc.); mnetadata with semantic meta-information, Charset information, Document Type Definition (DTD); diagrammatic and style information including information about rendered items (e.g., image size attributes) and visual specifications (e.g., Cascading Style Sheets); and scripts (e.g., JavaScript).

In some example embodiments, a copy of the set of instructions is saved locally at the client device 106. The set of instructions may be deleted at any time or stored indefinitely. The quick trace navigation system 110 may additionally cache the set of instructions within the database 120, as will be discussed in operation 315.

At operation 315, the caching module 215 caches the set of instructions within the database 120. For example, the caching module 215 may allocate a memory location to the page address (e.g., URL) within the database 120. In this way, the caching module 215 may access the database 120 at a later time to retrieve the set of instructions to render the web page at a later time without accessing the third party server 108. In some embodiments, the caching module 215 caches only a portion of the set of instructions (e.g., just the set of instructions related to the visible components of the web page).

The caching module 215 stores the set of instructions with a digital watermark. For example, the caching module 215 may identify a type of content displayed in the web page based on the set of instructions, and generate and assign a digital watermark to the web page based on the type identified. In further embodiments, the user 107 may simply provide a text string to the caching module 215 (e.g., through an interface at the client device 106), and assign the text string to the web page as a watermark to more easily retrieve the web page at a later time through a search request. The caching module 215 assigns the digital watermark to the set of instructions (and the page address) and caches the digital watermark with the set of instructions at the memory location allocated to the page address. For example, the digital watermark may include a text string indicating that the set of instructions corresponds to a product page for a particular item (e.g., “UNDER ARMOUR CURRY ONE SHOES,” “BASKETBALL SHOES,” “SNEAKERS”). In this way, the quick trace navigation system 110 enables the user 107 to conveniently access and retrieve web pages previously accessed through search requests.

At operation 320, the quick trace menu module 220 generates a navigation menu that includes a presentation of a screenshot of the web page, based on the set of instructions at the database 120. The screenshot is created by the quick trace menu module 220 based on the set of instructions stored at the database 120. For example, the quick trace menu module 220 may access the database 120 to retrieve sets of instructions for web pages which the user 107 has accessed on the client device 106 (e.g., in response to a search request), and based on the sets of instructions, render a screenshots. The screenshot includes a thumbnail image depicting a state of the web page the last time the user 107 accessed it, based on the set of instructions.

In some example embodiments, the user 107 may additionally provide a search query to the quick trace navigation system 110 via an interface presented at the client device 106. The search query may include one or more search terms that include text strings found in one or more of the digital watermarks stored in the database 120. The caching module 215 accesses the database 120 to retrieve a set of instructions based on the search query and the digital watermarks.

At operation 325, the presentation module 210 causes display of the navigation menu within a portion of the display of the client device 106. In some example embodiments, the presentation module 210 causes display of the navigation menu in response to a user input received at the client device 106. For example, a user 107 may provide a user input that includes a tactile input, such as a predefined gesture, into a touch enabled device (e.g., an upward or downward swiping motion). In response to the user input, the presentation module 210 causes the navigation menu to display within the interface of the client device 106. In some example embodiments, the presentation module 210 causes the navigation menu to appear as an overlay above content displayed in the interface of the client device 106.

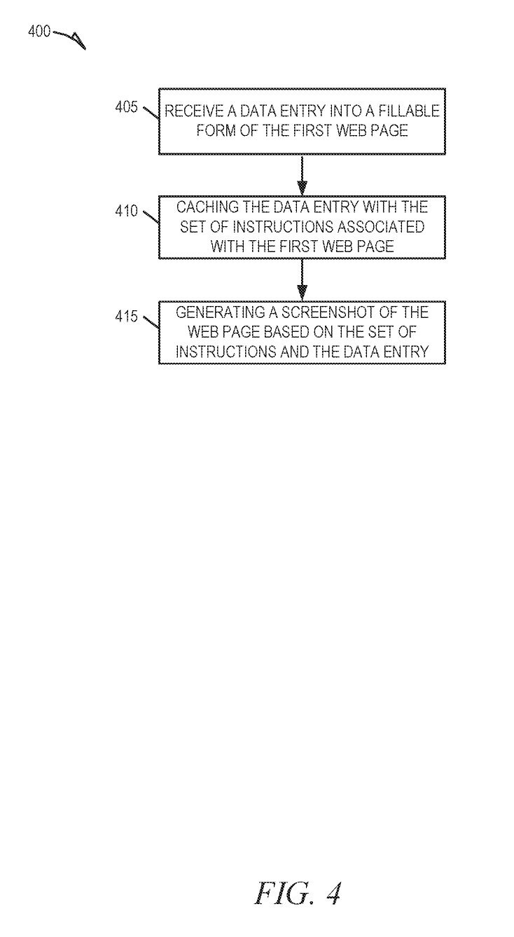

FIG. 4 is a flow chart illustrating a method 400 for generating screenshots to be displayed within a navigation menu by the quick trace navigation system 110, according to an example embodiment. The method 400 may be embodied in computer-readable instructions for execution by one or more processors (e.g., processors 225) such that the steps of the method 400 may be performed in part or in whole by functional components (e.g., modules) of the client device 106 or the quick trace navigation system 110; accordingly, the method 400 is described below by way of example with reference thereto. However, it shall be appreciated that the method 400 may be deployed on various other hardware configurations and is not intended to be limited to the functional components of the client device 106 or the quick trace navigation system 110.

One or more operations 405, 410, and 415 of the method 400 may be performed as part (e.g., a precursor task, a subroutine, or portion) of the method 300, in which the quick trace navigation system generates and causes display of a navigation menu at a client device 106, according to some example embodiments.

At operation 405, the client device 106 receives a data entry into a fillable form of a first web page displayed within an interface of the client device 106. The presentation module 210 may generate and cause display of a web page at the client device 106 based on a set of instructions. The set of instructions causes the presentation module 210 to generate and cause display of a fillable form that includes one or more fields to receive data entries as user inputs (e.g., selections, text strings). For example, the user 107 may provide text strings or selections into the fill able form (e.g., NAME: JOHN MATRIX, where the fillable form includes a “NAME:” field, and the user provides a text string “JOHN MATRIX”).

At operation 410, the caching module 215 caches the data entry with the set of instructions associated with the web page within the database 120. The set of instructions may be stored in the database 120 at a memory location associated with the page address. For example, in response to receiving the data entry into the fillable form of the web page, the caching module 215 identifies an appropriate memory location in the database 120 based on the page address of the web page, and stores the data entry with the set of instructions. By doing so, the caching module 215 may retrieve the set of instructions and the data entry at a later time by referencing the page address.

In some example embodiments, the caching module 215 omits sensitive data from being cached within the database 120. For example, the caching module 215 may determine that the data entries provided by the user 107 into the fillable form include sensitive information and private user data of the user 107 (e.g., social security numbers, credit card information) based on configurations provided by the user 107, or by an administrator of the quick trace navigation system 110. The quick trace navigation system 110 may be configured to receive a configuration that defines types of sensitive information that is to be omitted from the database 120, in order to maintain a level of privacy for the user 107. For example, the user 107 may not want certain information to be stored at a memory location outside of the client device 106. Having identified that the data entry includes sensitive information, the caching module 215 omits the data entry from the database 120.

At operation 415, the quick trace menu module 220 generates a screenshot of the web page based on the set of instructions and the data entry stored within the database 120, For example, the set of instructions may include rendering instructions to generate and cause display of visual aspects of the web page at the client device 106. The quick trace menu module 220 may generate a screenshot of the web page as it appeared at the time in which the set of instructions was cached based on the set of instructions and the data entry. The screenshot of the web page may be in the form of a thumbnail image (that depicts a small portion of the web page). The screenshot may then be inserted into the navigation menu to be displayed at the client device 106. In some example embodiments, the screenshot may also include an interactive component, such that by selecting the screenshot, a user 107 is directed to the web page depicted by the screenshot.

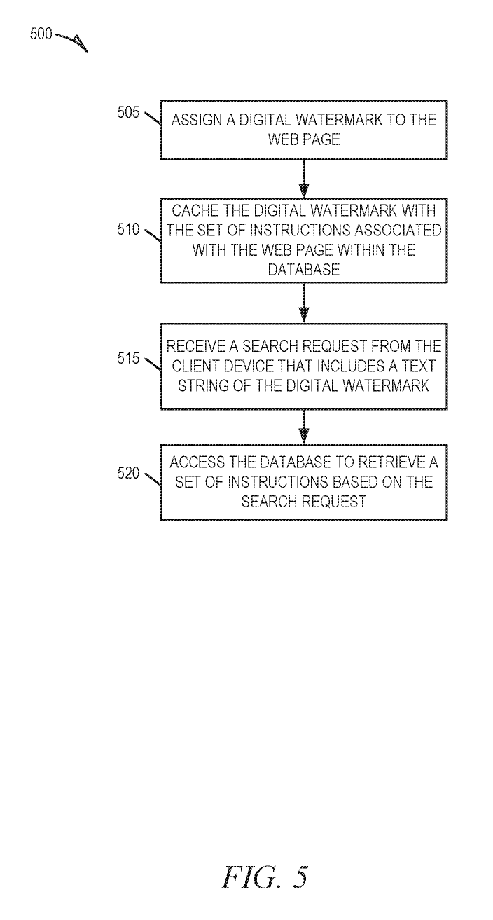

FIG. 5 is a flow chart illustrating a method 500 for retrieving screenshots to be displayed within the navigation menu at the client device 106 by the quick trace navigation system 110, according to an example embodiment. The method 500 may be embodied in computer-readable instructions for execution by one or more processors (e.g., processors 225) such that the steps of the method 500 may be performed in part or in whole by functional components (e.g., modules) of the client device 106 or the quick trace navigation system 110; accordingly, the method 500 is described below by way of example with reference thereto. However, it shall be appreciated that the method 500 may be deployed on various other hardware configurations and is not intended to be limited to the functional components of the client device 106 or the quick trace navigation system 110.

One or more operations 505, 510, 515 and 520 of the method 500 may be performed as part (e.g., a precursor task, a subroutine, or portion) of the method 300, in which the quick trace navigation system generates and causes display of a navigation menu at a client device 106, according to some example embodiments.

At operation 505, the caching module 215 assigns a digital watermark to the web. For example, the digital watermark may be based on the content of the web page, or be provided by the user 107, as discussed above with reference to the caching module 215 of FIG. 2. The digital watermark may include a text string. In some example embodiments, the caching module 215 may assign multiple digital watermarks to a single web page.

At operation 510, the caching module 215 caches the digital watermark with the set of instructions at a memory location within the database 120 based on the page address. A user (e.g., user 107) may thereby search for a particular web page (or web pages) based on the corresponding digital watermark (or watermarks).

At operation 515, the caching module 215 receives a search request from the client device 106. For example, the user 107 may enter the search request into an interface displayed at the client device 106. Should the user 107 wish to see all web pages which they previously accessed related to travel accommodations, the user 107 could input a search request into an interface at the client device 106 that includes the term “HOTELS.” In response to receiving the search query, the caching module 215 accesses the database 120 to identify relevant web pages based on the digital watermarks.

At operation 520, the caching module 215 retrieves the relevant sets of instructions based on the search request. For example, the database 120 may include multiple sets of instructions that correspond to distinct web pages, and each set of instructions may have one or more digital watermarks assigned to them. The caching module 215 may access the database 120 to retrieve the sets of instructions related to the received search request.

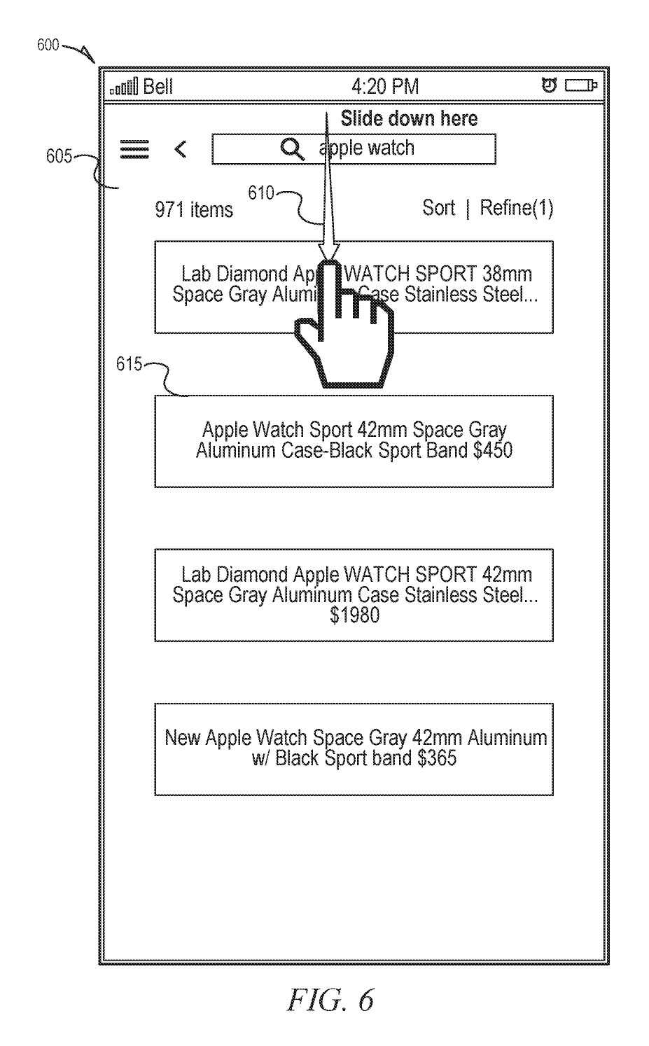

FIG. 6 is an interface diagram illustrating a user interface 600 displaying a web page 605 that includes content 615, according to an example embodiment. The user interface 600 may, for example, be presented on a touch enabled mobile device such as the client device 106. As shown, a user 107 may provide a user input 610 into the interface 600. The user input 610 includes a predefined gesture, such as a downward or upward swiping motion on the interface 600.

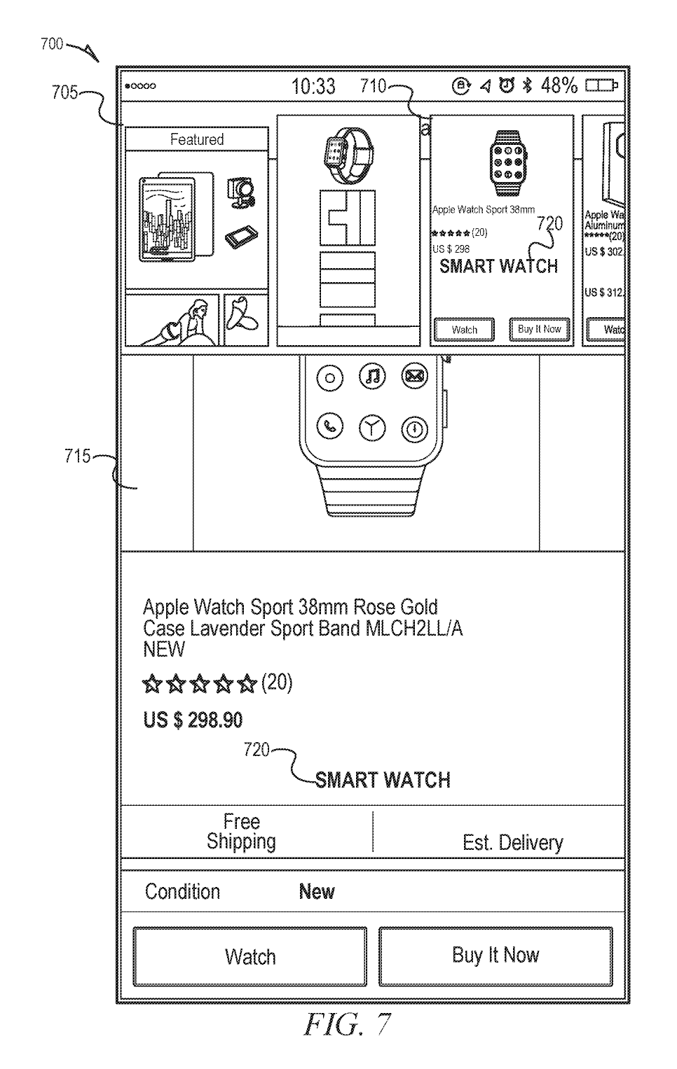

FIG. 7 is an interface diagram illustrating a user interface 700 at a client device (e.g., at a client device 106) displaying a navigation menu 705 containing screenshots (e.g., screenshot 710) of web pages (e.g., web page 715) a user has previously accessed, according to an example embodiment. The navigation menu 705 may be displayed within the interface 700 in response to a user input, such as the user input 610 depicted in FIG. 6. For example, a user 107 may provide the user input 610 into the client device 106, and in response, the quick trace navigation system 110 may cause display of the navigation menu 705 at a location within the interface 700.

As shown in FIG. 7, the user interface 700 displays a web page 715. The web page 715 is displayed at the client device based on a corresponding set of instructions retrieved by the browser module 205 from a third party server 108. For example, a user 107 provides a URL to the browser module 205, and in response, the browser module 205 retrieves a set of instructions from the third party server 108 to render the web page 715. The caching module 215 caches the set of instructions corresponding to the web page 715 within the database 120. In some embodiments, as discussed in FIG. 5, the caching module 215 assigns a digital watermark 720 to the web page 715. In some example embodiments, the digital watermark 720 is displayed within the web page 715. For example, the user 107 may select a particular color, pattern, or font of the digital watermark 720, in order to more easily identify the digital watermark among a set of screenshots (e.g., screenshot 710).

As discussed in FIG. 3, in response to receiving a user input to display the navigation menu 705, the quick trace menu module 220 causes display of the navigation menu 705 at a position within the interface 700. In some example embodiments, the quick trace menu module 220 overlays the navigation menu 705 above a web page currently displayed within the interface 700 (e.g., web page 715). In instances where the navigation menu is overlaid on top of the interface 700, the navigation menu 705 may be displayed with a degree of opacity, such that aspects of the web page 715 may be visible beneath the navigation menu 705.

The navigation menu 705 includes a presentation of screenshots (e.g., screenshot 710) of web pages (e.g., web page 715). The screenshots displayed within the navigation menu 705 are generated according to the method discussed in FIG. 4, wherein the quick trace menu module 220 generates a screenshot of the web page based on the set of instructions stored within the database 120. As the user 107 views the navigation menu 705, the user may provide user inputs to scroll or swipe the navigation menu and display additional screenshots. In some example embodiments, the screenshots (e.g., screenshot 710) may be displayed chronologically, or by relevance of corresponding digital watermarks to a search request received from the client device 106. The screenshots generated by the quick trace menu module 220 may also include a digital watermark (e.g., digital watermark 720). By displaying the digital watermark 720 within the screenshots in the navigation menu 705, a user 107 may more quickly identify relevant web pages. The user 107 may navigate to a web page of a screenshot by selecting the screenshot (e.g., on a touch enabled device).

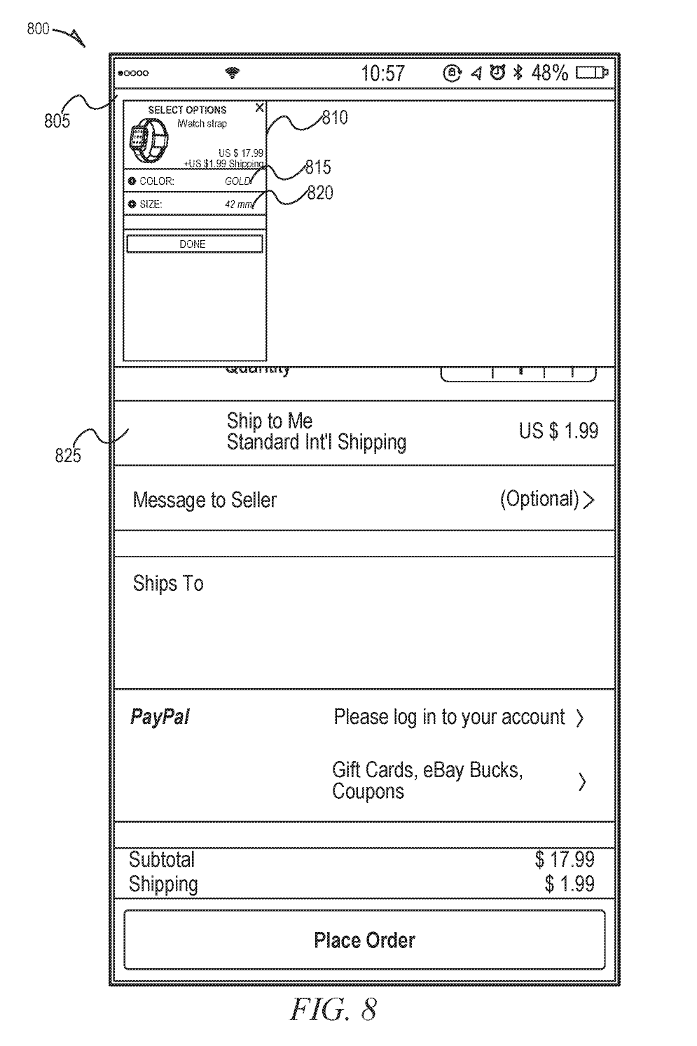

FIG. 8 is an interface diagram illustrating an interface 800 configured to display a web page 825, and a navigation menu 805 overlaid on top of the web page 825 and containing a screenshot 810, according to an example embodiment. As shown in FIG. 8, the screenshot 810 corresponds with a web page distinct from the web page 825, and includes a fillable form with user selectable options 815 and 820. The user 107 provides user inputs (e.g., data entries) for the user selectable options 815 and 820. For example, the user 107 may select, or specify through a text string input into the fillable form, a color (e.g., user selectable option 815), and a size (e.g., user selectable option 820). The caching module 215 stores the user entries (e.g., the user selectable options 815 and 820) within the database 120 at a memory location associated with the corresponding web page displayed in the screenshot 810.

As discussed in FIG. 4, a user may provide data entries into a fillable form displayed within a web page. The data entries provided by the user may then be stored by the caching module 215 within the database 120. The quick trace menu module 220 may thereby generate a screenshot (e.g., screenshot 810) of the webpage based on the corresponding set of instructions and the data entry provided by the user 107. The user 107 may select the screenshot 810, and in response, the quick trace navigation system 110 renders and causes display of the corresponding web page at the client device 106.

### Machine Architecture

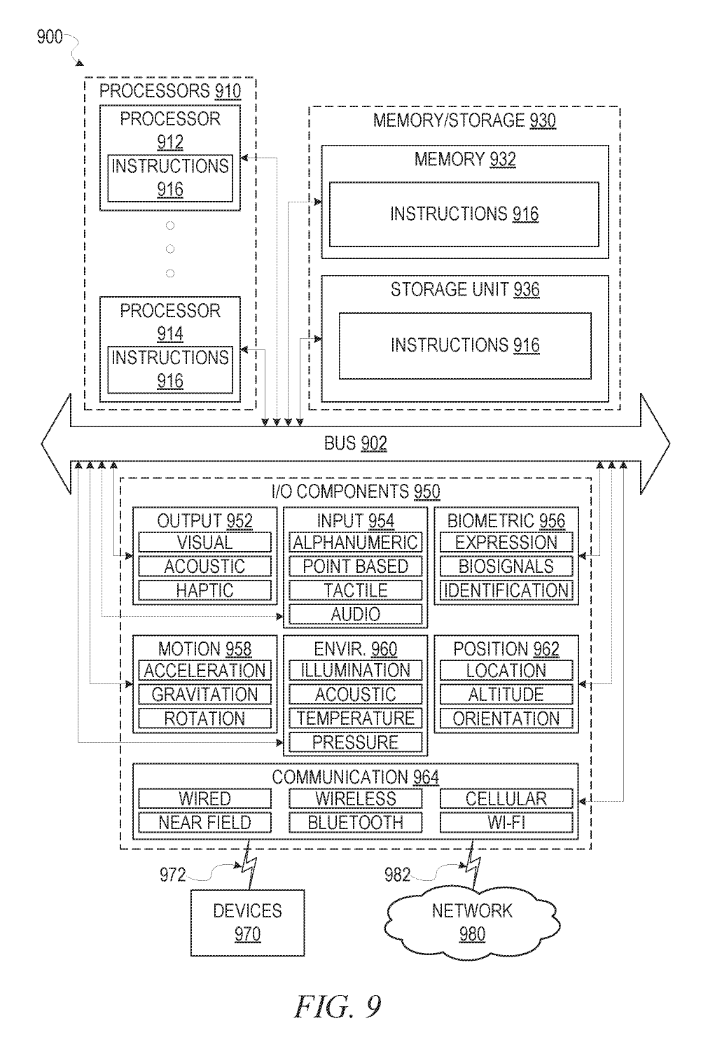

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. These instructions transform the general, non-programmed machine into a specially configured machine programmed to carry out the described and illustrated functions described herein. Consistent with some embodiments, the machine 900 may correspond to the client device 106 or the quick trace navigation system 110.

The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. By way of non-limiting example, the machine 900 may comprise or correspond to a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and input and output (I/O) components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 1000. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1016. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED)) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972, respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

Although the embodiments discussed herein have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document: for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A system comprising:
one or more processors; and
a memory storing instructions that, when executed by at least one processor among the one or more processors, cause the system to perform operations comprising:
receiving a first page address that identifies a first web page via a client device of a first user;
rendering the first web page within an interface at the client device based on a set of instructions to render the first web page, in response to the receiving the first page address;
caching the set of instructions to render the first web page within a memory location of a database associated with the first page address of the first web page;
generating a navigation menu that includes a screenshot of the first web page based on the set of render instructions; and
causing display of the navigation menu within a portion of the interface at the client device.

2. The system of claim 1, wherein the first web page includes a fillable form, and the instructions cause the system to perform operations further comprising:
receiving a data entry into the fillable form, the data entry including a text string;
caching the data entry at the memory location associated with the first page address within the database; and
wherein the presentation of the screenshot of the first web page includes the data entry in the fillable form.

3. The system of claim 1, wherein the client device is a touch enabled device, and the instructions for causing display of the navigation menu include:
receiving a user input from the client device, the user input including a tactile input to the client device; and
generating the screenshot of the first web page in response to receiving the tactile input.

4. The system of claim 3, wherein the tactile input includes a swiping motion onto the touch enabled device.

5. The system of claim 1, wherein the first page includes content, the screenshot is a first screenshot, and the instructions further comprise:
assigning a digital watermark to the first web page based on the content, the digital watermark including a text string; and
wherein the first screenshot of the first web page includes the digital watermark;
caching the digital watermark with the first page address and the first web page within the database associated with the first user;
receiving a search request from the client device, the search request including the text string of the digital watermark; and
wherein the generating the navigation menu includes accessing the database to retrieve a set of screenshots of web pages accessed by the first user at the client device based on the search request, the set of screenshots including at least the first screenshot.

6. The system of claim 1, wherein the instructions for causing display of the navigation menu includes:
overlaying the navigation menu on top of the first web page within the interface at the client device.

7. The system of claim 1, wherein the instructions cause the system to perform operations further comprising:
identifying sensitive data within the first web page, the sensitive data including private user data of the first user; and
omitting the sensitive data from the screenshot displayed within the navigation menu.

8. The system of claim 1, wherein the screenshot of the first web page is a thumbnail image.

9. A method comprising:
receiving a first page address that identifies a first web page via a client device of a first user;
rendering the first web page within an interface at the client device based on a set of instructions to render the first web page, in response to the receiving the first page address;
caching the set of instructions to render the first web page within a memory location of a database associated with the first page address of the first web page;
generating a navigation menu that includes a screenshot of the first web page based on the set of render instructions; and
causing display of the navigation menu within a portion of the interface at the client device.

10. The method of claim 9, wherein the first web page includes a fillable form, and the method further comprises:
receiving a data entry into the fillable form, the data entry including a text string;
caching the data entry at the memory location associated with the first page address within the database; and
wherein the presentation of the screenshot of the first web page includes the data entry in the fillable form.

11. The method of claim 9, wherein the client device is a touch enabled device, and the method includes:
receiving a user input from the client device, the user input including a tactile input to the client device; and
generating the screenshot of the first web page in response to receiving the tactile input.

12. The method of claim 11, wherein the tactile input includes a swiping motion onto the touch enabled device.

13. The method of claim 9, wherein the first page includes content, the screenshot is a first screenshot, and the method further comprises:
assigning a digital watermark to the first web page based on the content, the digital watermark including a text string; and
wherein the first screenshot of the first web page includes the digital watermark;
caching the digital watermark with the first page address and the first web page within the database associated with the first user;
receiving a search request from the client device, the search request including the text string of the digital watermark; and
wherein the generating the navigation menu includes accessing the database to retrieve a set of screenshots of web pages accessed by the first user at the client device based on the search request, the set of screenshots including at least the first screenshot.

14. The method of claim 9, wherein the method includes:
overlaying the navigation menu on top of the first web page within the interface at the client device.

15. The method of claim 9 further comprising:
identifying sensitive data within the first web page, the sensitive data including private user data of the first user; and
omitting the sensitive data from the screenshot displayed within the navigation menu.

16. A non-transitory machine-readable storage medium comprising instructions that, when executed by one or more processors of a machine, cause the machine to perform operations comprising:
receiving a first page address that identifies a first web page via a client device of a first user;
rendering the first web page within an interface at the client device based on a set of instructions to render the first web page, in response to the receiving the first page address;
caching the set of instructions to render the first web page within a memory location of a database associated with the first page address of the first web page;
generating a navigation menu that includes a screenshot of the first web page based on the set of render instructions; and
causing display of the navigation menu within a portion of the interface at the client device.

17. The non-transitory machine-readable storage medium of claim 16, wherein the first web page includes a fillable form, and the operations further comprise:
receiving a data entry into the fillable form, the data entry including a text string;
caching the data entry at the memory location associated with the first page address within the database; and
wherein the presentation of the screenshot of the first web page includes the data entry in the fillable form.

18. The non-transitory machine-readable storage medium of claim 16, wherein the client device is a touch enabled device, and the operations further include:
receiving a user input from the client device, the user input including a tactile input to the client device; and
generating the screenshot of the first web page in response to receiving the tactile input.

19. The non-transitory machine-readable storage medium of claim 18, wherein the tactile input includes a swiping motion onto the touch enabled device.

20. The non-transitory machine-readable storage medium of claim 16, wherein the first page includes content, the screenshot is a first screenshot, and the operations further comprise:
assigning a digital watermark to the first web page based on the content, the digital watermark including a text string; and
wherein the first screenshot of the first web page includes the digital watermark;
caching the digital watermark with the first page address and the first web page within the database associated with the first user;
receiving a search request from the client device, the search request including the text string of the digital watermark; and
wherein the generating the navigation menu includes accessing the database to retrieve a set of screenshots of web pages accessed by the first user at the client device based on the search request, the set of screenshots including at least the first screenshot.
